(19) United States
(12) Patent Application Publication
(10) Pub. No.: US 2004/0199361 A1
(43) Pub. Date: Oct. 7, 2004

(54) Method and apparatus for equipment diagnostics and recovery with self-learning

(76) Inventors: Ching-Shan Lu, Hsin-Chu (TW); Shi-Rung Chen, Hsin-Chu (TW)

Correspondence Address: TAIWAN SEMICONDUCTOR MANUFACTURING CO., LTD., C/O SLATER & MATSIL, L.L.P., 17950 PRESTON ROAD, SUITE 1000, DALLAS, TX, 75252, US

(21) Appl. No.: 10/405,007

(22) Filed: Apr. 1, 2003

(51) Int. Cl. G06F 15/00

(52) U.S. Cl. 702/183

(57) ABSTRACT

System and method for semiconductor fabrication equipment diagnostics and recovery with self-learning. A preferred embodiment comprises an abnormal inference engine (for example, abnormal inference engine 205) coupled to a data source (for example, data source 210) that includes sensors and measuring equipment. The abnormal inference engine receives data associated with a trigger event and evaluates the data to satisfy one or more diagnostic rules. The satisfied diagnostic rules are associated with root causes, which in turn, are diagnosed to provide a remedy. The remedy along with pertinent data is displayed on a display (for example, display terminal 215). Feedback (provided by an engineer via a data terminal (for example, abnormal handle graphical user interface 220)) related to the remedy is used to help make adjustments to the abnormal inference engine and to assist in the diagnosis of future trigger events, providing a measure of self-learning.

### TECHNICAL FIELD

The present invention relates generally to a system and method semiconductor fabrication, and more particularly to a system and method for semiconductor fabrication equipment diagnostics and recovery with self-learning.

### BACKGROUND

Generally, equipment used in the fabrication of semiconductor devices is very complex and expensive. In fact, the semiconductor fabrication equipment located at fabrication plants may cost in the excess of billions of dollars. Due to their complexity and cost, the fabrication equipment receives extensive maintenance and care. Additionally, the fabrication equipment may contain a sensor (or a series of sensors) to keep track on the performance of the equipment. The sensor(s) may be used to keep track on the performance of the equipment themselves, or the sensor(s) may monitor the output of the equipment.

Should the sensor(s) report a piece of equipment not performing to specifications or an output of the equipment not meeting specifications, then necessary adjustments and/or repairs will be made to the equipment. While constant adjustments and/or repairs may be expensive, the constant maintenance may actually prevent a catastrophic failure that can be much more expensive in the long run.

A typical adjustment or repair would begin with a sensor(s) detecting a piece of equipment that is not operating within specified parameters (or an output of a piece of equipment not meeting specifications), then the sensor would provide the information to an engineer (or process engineer) via an information display device. The information display device may be as simple as a simple light emitting diode (LED) or as complex as a window in a fully operational graphical user interface (GUI) on a computer display terminal. The engineer would then use the information provided by the display, perhaps apply some engineering knowledge, and make any necessary adjustments to the equipment.

One disadvantage of the prior art is that an engineer would need to possibly decipher the information provided by the sensor(s) in order to determine what part of the fabrication equipment needs to be adjusted and/or fixed.

A second disadvantage of the prior art is that an engineer would necessarily need to have a certain level of expertise in order to decipher the information provided by the sensor(s). This would imply that the engineer has a minimum level of knowledge or that the engineer has the capability to confer with other engineer(s) with suitable knowledge in order to process the sensor information.

A third disadvantage of the prior art is that a single engineer may not be able to respond to information provided by each sensor located at the various fabrication equipments. Therefore, there may be a need for multiple engineers to be on duty to adequately respond to problems detected by sensors throughout the fabrication facility.

### SUMMARY OF THE INVENTION

These and other problems are generally solved or circumvented, and technical advantages are generally achieved, by preferred embodiments of the present invention which provide a system and method for diagnosing semiconductor fabrication equipment with an ability to self-learn from the use of feedback information provided by engineers.

In accordance with a preferred embodiment of the present invention, a method for diagnosing an abnormality comprising receiving data from a trigger event, evaluating satisfaction of diagnostic rules using received data, determining a root cause if at least one diagnostic rule is satisfied, and displaying the root cause if at least one diagnostic rule is satisfied, else displaying the received data.

In accordance with another preferred embodiment of the present invention, a method for self-learning diagnostics comprising receiving data from a trigger event, evaluating satisfaction of diagnostic rules using received data, if at least one diagnostic rule is satisfied, then determining a root cause, diagnosing a remedy for the root cause, displaying the remedy, receiving feedback information about the remedy, and modifying the satisfied diagnostic rule with the feedback information.

In accordance with another preferred embodiment of the present invention, an equipment diagnosis system comprising a data source to provide information from sensors and measuring equipment, an inference engine coupled to the data source, the inference engine containing circuitry to evaluate the information provided by the data source and to diagnose a root cause from the information, a display coupled to the inference engine, the display to interface the inference engine with a user, and a database coupled to the inference engine, the database to store information provided by the data source and the diagnosis generated by the inference engine.

An advantage of a preferred embodiment of the present invention is that a single engineer at a display terminal may be able to monitor the performance of fabrication equipment throughout a fabrication plant.

A further advantage of a preferred embodiment of the present invention is that the engineer need not necessarily have to have a relatively high level of experience or expertise due to the fact that the problem with the fabrication equipment is clearly provided and little or no deciphering of provided information is needed.

Yet another advantage of a preferred embodiment of the present invention is through feedback information provided by the engineer(s) on previously detected problems with the fabrication equipment and suggested fixes, the performance of problems detected and suggested fixes in the future may be improved.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a prior art diagram of manufacturing equipment with sensors and displays with an engineering to provide maintenance;

FIG. 2 is a diagram of a manufacturing equipment monitoring system with a built-in self-learning ability, wherein information provided by different groups of sensors are combined and displayed at a single display, according to a preferred embodiment of the present invention;

FIG. 3 is a diagram providing a detailed view of an equipment abnormal inference engine (EIEA) and data source, according to a preferred embodiment of the present invention;

FIG. 4 is a diagram illustrating a portion of an abnormal cause diagnostic, wherein diagnostic rules for several root causes are displayed, according to a preferred embodiment of the present invention;

FIG. 5 is a diagram illustrating a portion of an abnormal cause diagnostic, wherein diagnostic rules a root cause is displayed, according to a preferred embodiment of the present invention;

FIG. 6 is a diagram illustrating a high-level view of the use of feedback information provided by an engineer to help improve suggest remedies made by an EIEA, according to a preferred embodiment of the present invention; and

FIG. 7 is a flow diagram illustrating an algorithm used in monitoring manufacturing equipment for problems and abnormal events and for providing data to assist an engineer in correcting the problems, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a semiconductor fabrication plant with fabrication equipment. The invention may also be applied, however, to other manufacturing equipment that needs continual monitoring to ensure that the equipment is operating in specifications and the product of the equipment is meeting requirements.

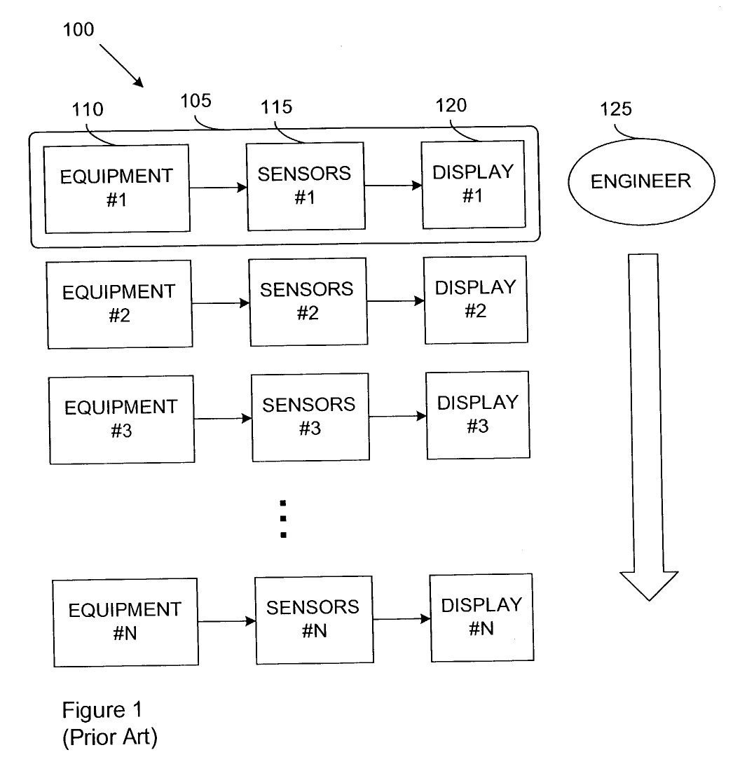

With reference now to FIG. 1, there is shown a figure displaying a prior art diagram of manufacturing equipment in a manufacturing facility 100 with sensors and displays and an engineer(s) to provide maintenance for the manufacturing equipment. The manufacturing facility 100 has a plurality of manufacturing equipment/sensor/display combinations (for example, combination 105) that are used to produce a product (not shown), for example, a semiconductor device.

Each manufacturing equipment/sensor/display combination (for example, combination 105) includes a piece of manufacturing equipment 110, one or more sensors 115, and a display 120 that is used convey the information provided by the sensor 1115. The piece of manufacturing equipment in each combination may be similar to other pieces of manufacturing equipment in other combinations or it may be different. For example, the combinations may be similar (or identical) and may operate in parallel to produce a large number of a certain type of product. Alternatively, the combinations may be different and a product produced by one piece of manufacturing equipment may be used by a subsequent piece of manufacturing equipment, with an end result being a single product.

The manufacturing facility 100 also has one or more engineers 125 working during the times when the manufacturing facility 100 is in operation. It may be one of the engineer's job functions to ensure that the manufacturing equipment in the manufacturing facility 100 is operating within established parameters and that the product produced by the manufacturing equipment is within specifications. Depending upon the number and complexity of the manufacturing equipment, more than one engineer 125 may be working at the same time.

Each manufacturing equipment/sensor/display combination may operate as follows: during operation, the sensor 115 monitors various aspects of the manufacturing equipment 110, such as the time, temperature, pressure, and so forth. The sensor 115 may also monitor the product (not shown) produced by the manufacturing equipment 110. If the manufacturing equipment 110 or the product or both are out of specifications, the sensor 115 can display relevant information on the display 120. The display 120 may be as simple as a light emitting diode (LED) or as complex as a graphical display on a computer display terminal.

The engineer 125 must then decipher the information provided by the sensors on the display. Depending on the amount of information provided by the sensors and the complexity of the problem, the engineer 125 may or may not have to perform much work in deciphering the information displayed. On more complex problems, the engineer's experience and expertise may have a large impact upon the timeliness of the engineer's reaction to the detected problem. If the engineer 125 is not able to decipher the information and devise a corrective measure or if he is not able to correct the problem, the engineer 125 may decide to enlist the assistance of additional engineers, some with perhaps more experience.

Once a corrective measure has been devised, the engineer 125 may then apply the corrective measure to the manufacturing equipment 110. The corrective measure may require that the manufacturing equipment 110 be shut-down while the fix is being applied. Additionally, the sensor 115 may require being reset once the corrective measure has been applied.

The manufacturing equipment monitoring system as illustrated in FIG. 1 can be described as a distributed system, wherein each particular piece (or group) of manufacturing equipment is monitored by a different sensor (or groups of sensors). The monitoring system would then require an engineer to continually monitor the various displays to obtain up-to-date information on the many different pieces of manufacturing equipment throughout the manufacturing plant. Alternatively, multiple engineers would be employed to monitor different subsets of displays should the total number of displays be too great for a single engineer to monitor.

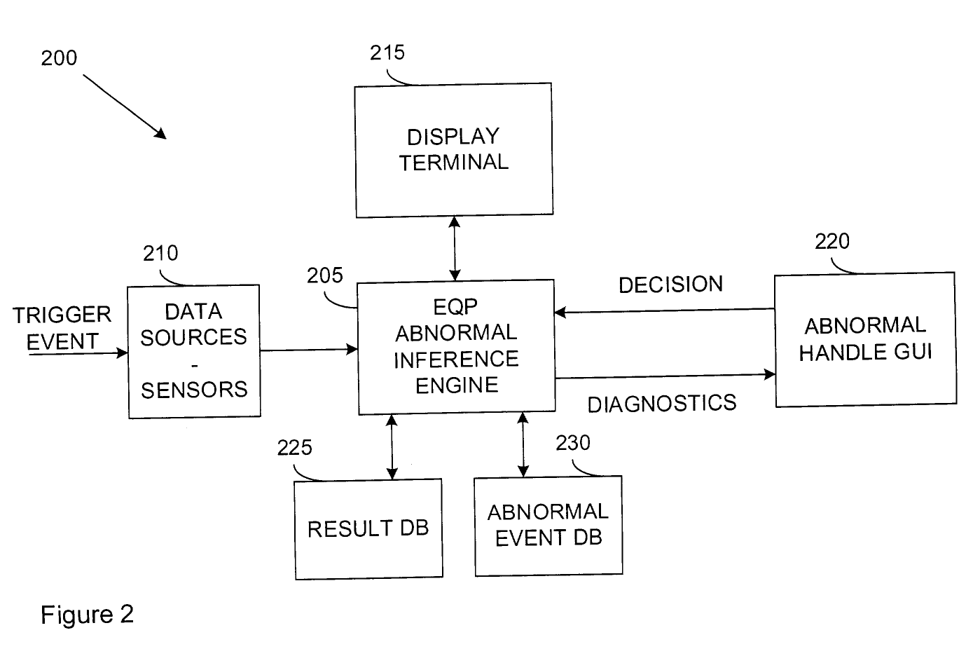

With reference now to FIG. 2, there is shown a diagram illustrating a manufacturing equipment monitoring system 200 with a built-in self-learning ability, wherein information provided by different groups of sensors are combined and displayed at a single display, according to a preferred embodiment of the present invention. The monitoring system 200 can be used to combine information provided by a plurality of sensors (not shown) to provide manufacturing equipment status to an engineer. Additionally, with a built-in expert system, the monitoring system 200 can pin point problem areas in the manufacturing equipment and even propose remedies. Also, through the use of feedback information provided by the engineer, the monitoring system 200 can perform “self-learning,” rating the effectiveness of its proposed remedies, and perhaps adjust its future proposed remedies based on the effectiveness ratings.

At the heart of the monitoring system 200 is an equipment (EQP) abnormal inference engine (EAIE) 205. The EAIE 205 is an expert system can take one or more input data (in the case of the monitoring system 200, the input may include sensor data from various manufacturing equipment) and produce an output data (in the case of the monitoring system 200, the output may include a display of the problematic manufacturing equipment, what has gone wrong, and a proposed remedy). The EAIE 205 makes use of the technical knowledge of engineers put in the form of rules to process the input data and to produce the output data. The rules can be created by interviewing the engineers and the rules may be updated as the need arises. Expert systems are useful for converting human knowledge into mechanical and computer systems that are usable without humans and are considered to be well understood by those of ordinary skill in the art of the present invention.

Input to the EAIE 205 may come from one or more of a plurality of data sources 210. Data provided by the data sources 210 may be derived from sensors and other measurement equipment coupled to the manufacturing equipment. Examples of sensors and measurement equipment may include but are not limited to temperature, pressure, position, video, power sensors, and so forth. The data sources 210 can also provide information about the products produced by the manufacturing equipment, for example, semiconductor wafers being produced in a semiconductor fabrication plant as it is moved among various fabrication equipment. The data sources 210 may provide information regarding the status of the manufacturing plant itself, for example, the temperature of the facility, the presence of water (perhaps unwanted) in the facility, availability of power in various parts of the facility, and so on.

When an event occurs in the manufacturing equipment, product, or the manufacturing facility that is outside of some specified parameter or specifications (often referred to as a trigger event), the data source 210 (a sensor or piece of measurement equipment in the data source 210) will detect the occurrence and provides information related to the occurrence to the EIEA 205. For example, if it is the temperature of a portion of a piece of manufacturing equipment that has exceeded a specified parameter, the information provided by the sensor to the EIEA 205 may include the current temperature, when the temperature exceeded the specified parameter, how rapidly the temperature is changing, and so forth.

The EIEA 205 takes the information related to the trigger event (and perhaps other information provided by the data source 210) and in combination with the inference rules programmed into it, the EIEA 205 may produce a display related to the trigger event and perhaps suggest a possible remedy. According to a preferred embodiment of the present invention, the EIEA 205 produces the display at a display terminal 215. The display terminal 215 may be as simple as a text-based computer terminal or as complex as a window in a graphical user interface (GUI). The display terminal 215 should be located at a location where it can be easily monitored by an engineer (or some other person who is responsible for such duties). The engineer can then interact with the EIEA 215 to determine information regarding the trigger event that will help him correct the problem. As stated previously, the EIEA 215 may even be able to suggest a remedy.

Trigger events detected by the EIEA 205 and information (and remedies) produced by the EIEA 205 may be optionally stored in a database. For example, the trigger event may be stored in an abnormal event database 230 and the information, along with possibly remedy, may be stored in a result database 225. The storage of the trigger events and associated information and remedies can be used to provide a record of the performance of the manufacturing equipment. The stored data can also be historical information related to the performance of the EIEA 205, then, should a trigger event occur that is already stored in the database, the stored data can be compared with the information and remedy provided by the EIEA 205. The comparison can be used to make adjustments to a remedy provided by the EIEA 205.

According to a preferred embodiment of the present invention, a feature of the EIEA 205 is its ability to make use of feedback information provided by users of the monitoring system 200 to help it improve its diagnostic performance. For example, when a particular type of trigger event occurs, the EIEA 205 may suggest a possible remedy. An engineer may make use of the suggested remedy to attempt to correct the problem. After the problem has been remedied, the engineer may provide feedback regarding the performance of the suggested remedy. The EIEA 205 could then save the feedback information in its databases. When a similar (or same) type of trigger event occurs in the future, the EIEA 205 could search its databases for previously suggested remedies, their effectiveness, and other pertinent information. The EIEA 205 could then decide to suggest a new remedy if previous remedies have not been particularly effective. Alternatively, if previous remedies have been relatively effective, but not entirely effective, feedback information provided by the engineer may provide suggestions as to modifications that may increase the effectiveness of the EIEA's remedies.

The engineer can provide feedback information regarding a remedy suggested by the EIEA 205 through an abnormal handle interface 200. The abnormal handle interface 220 may be a data terminal where the engineer can enter data related to the performance of the remedy. Alternatively, the abnormal handle interface 220 may be a touch screen display, personal digital assistant (PDA), laptop computer, tablet computer, smart cellular telephone, and so forth that can be coupled to the EIEA 205 via a wired or wireless communications link.

Alternatively, the effectiveness of a suggested remedy can be provided to the EIEA 205 automatically through the various sensors and detection equipment that is part of the data source 210. The EIEA 205 can automatically monitor the information provided by the data source 210 and determine the effectiveness of the suggested remedy based on the information.

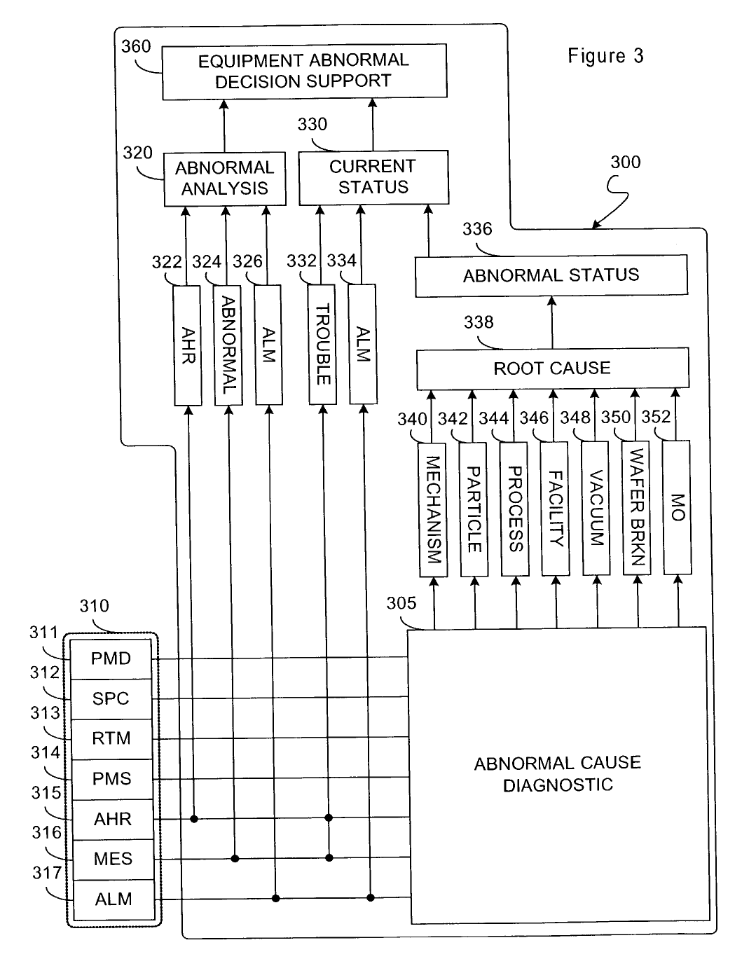

With reference now to FIG. 3, there is shown a diagram providing a detailed view of an EIEA 300 and data source 310, according to a preferred embodiment of the present invention. The data source 310 provides data input to the EIEA 300 in a manner consistent with the data source 210 (FIG. 2). As displayed in FIG. 3, the data source 310 can provide data from sensors and measurement equipment concerning, but not limited to: particle map data (PMD) 311, statistic process control (SPC) 312, real-time monitoring (RTM) 313, prevention maintenance system (PMS) 314, abnormal handler record (AHR) 315, manufacturing execution system (MES) 316, and alarm (ALM) 317. This data and other data (depending upon configuration of the data source) are provided to the EIEA 300.

When a trigger event results in the generation of data by sensors and measurement equipment (not shown) located in the data source 310, the EIEA 300 takes the data provided by the data source 310 and applies the data to a set of diagnostic rules to determine a root cause for the trigger event. The diagnostic rules for the various root causes are displayed as an abnormal cause diagnostic box 305 and are discussed in greater detail below. There may be a multitude of root causes and for each root cause, there may be a unique diagnostic rule. Examples of root causes may include but are not limited to mechanical, particle, process, facility, vacuum, wafer broken, and mis-operation (MO). The root causes, as displayed in FIG. 3 as root cause indicators, may simply be registers, flip-flops, latches, memory locations or some flags that are designated as representing the assertion of one or more of these root causes. The logic for determining the root causes are in the abnormal cause diagnostic 305. Diagnostic rules for each of the listed root causes will be discussed below. It should be evident that other root causes may be possible and that diagnostic rules for the root causes not discussed can readily be derived.

After the data from the data source 310 is provided to the abnormal cause diagnostic 305, and a root cause is determined (note that it is possible to have more than one root cause), then the corresponding root cause indicator (for example, mechanism 340, particle 342, process 344, and so forth) is asserted. If there are more than one root causes, then more than one root cause indicators are asserted.

When one or more of the root cause indicators (for example, facility 346, MO 352, and so forth) is asserted, then a root cause for the trigger event has been determined. This may be represented by a root cause indicator 338, which, like the root cause indicators, may be a memory, register, flip-flop, latch, or others. The assertion of the root cause indicator 338 will in turn result in the assertion of an abnormal status indicator 336.

Operating in conjunction with the abnormal cause diagnostic 305 and making use of information provided by the abnormal cause diagnostic 305 is a portion of the EIEA 300 that provides information about the current status of the manufacturing equipment (a current status operator 330). The current status operator 330 serves to provide up-to-date information about the manufacturing equipment. According to a preferred embodiment of the present invention, the current status operator 330 makes use of a combination of data from the AHR 315, MES 316, and ALM 317 data sources along with the abnormal status indicator 336. Note however, that it is possible to use data from other data sources. The AHR 315 may provide access to saved incidents of manufacturing equipment problems and/or abnormal events, while the MES 316 may provide current information regarding a current problem or abnormal event. Other data sources (for example, PMD 311, SPC 312, and so forth) are processed by the abnormal cause diagnostic 305 prior to being combined in the current status operator 330.

While the current status operator 330 makes use of current, up-to-the-minute data as provided by the data source 310, a different portion of the EIEA 300 makes use of historical data. This portion of the EIEA 300 is referred to as an abnormal analysis section 320. According to a preferred embodiment of the present invention, the abnormal analysis section 320 uses a combination of data from the AHR 315, MES 316, and ALM 317. Note however, that it is possible to use data from other data sources. The AHR 315 may provide access to saved incidents of manufacturing equipment problems and/or abnormal events, while the MES 316 may provide current information regarding a current problem or abnormal event and the ALM 317 can be used to notify the occurrence of the current problem or abnormal event.

The abnormal analysis section 320 may operate as follows: after a problem or abnormal event occurs, the ALM 317 is used to notify the EIEA 300 of the occurrence of the problem or abnormal event. The MES 316 provides the abnormal analysis section 320 with information related to the problem or abnormal event. It is the information provided by the MES 316 that can be used to determine the cause and nature of the problem or abnormal event. The cause and nature of the problem or abnormal event is then used to access the AHR 315 data. The AHR 315 is accessed to retrieve pertinent information related to any similar (or same) types of problems that has occurred in the past. The pertinent information retrieved may contain information regarding suggested remedies, any feedback information provided by engineers, and so forth. The abnormal analysis section 320 can then process the information and help provide a remedy that can effectively correct the problem or abnormal event using historical information.

Output of the abnormal analysis section 320 and the current status operator 330 are then combined in an equipment abnormal decision support 360. The equipment abnormal decision support 360 then uses the remedy (or remedies) suggested by the abnormal analysis section 320 and the information provided by the current status operator 330 (including a possible root cause(s) and current status) to select and provide a remedy to the engineer via a display (such as the display terminal 215 (FIG. 2)).

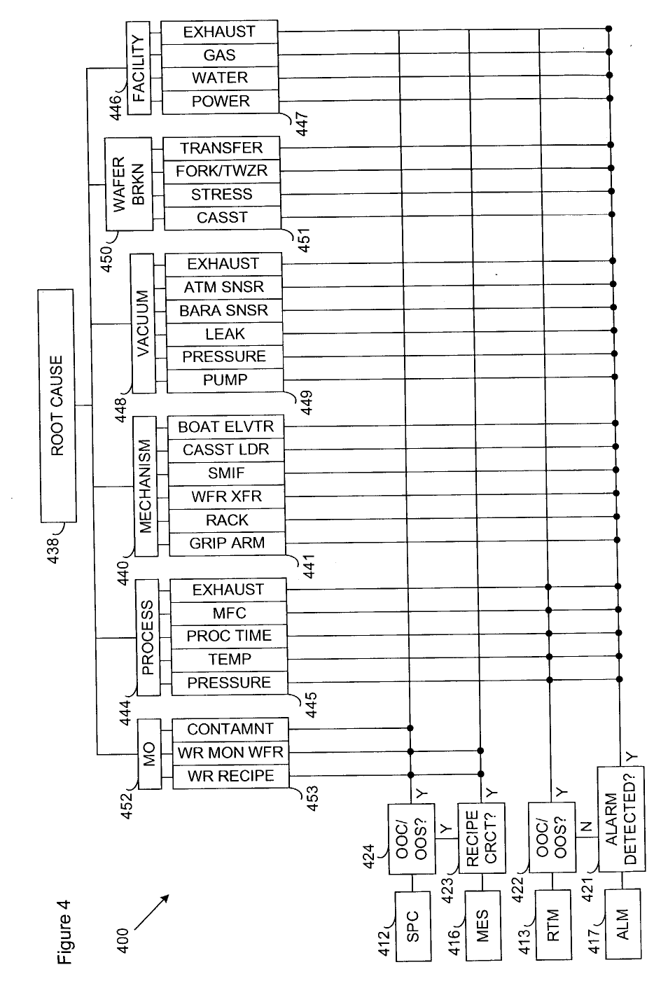

With reference now to FIG. 4, there is shown a diagram illustrating a portion of an abnormal cause diagnostic (such as the abnormal cause diagnostic 305 (FIG. 3)), wherein diagnostic rules for several root causes are displayed, according to a preferred embodiment of the present invention. As displayed in FIG. 4, a diagnostic rule may be a combination different data from a data source (such as the data source 310 (FIG. 3)). When a particular combination of data occurs (as specified by the diagnostic rule), then the diagnostic rule that makes use of that particular unique combination of data is satisfied and the root cause associated with the diagnostic rule is determined to have occurred. FIG. 4 displays exemplary diagnostic rules for mis-operation 442, process 444, mechanism 440, vacuum 448, wafer broken 450, and facility 446 related root causes.

Taking a closer look at an exemplary diagnostic rule for a mis-operation (MO) 452. The diagnostic rule for MO may be specified as a combination of several data events and is as follows: CONTAMINANT and WRONG MONITORED WAFER and WRONG RECIPE. When these three data events occur, then the diagnostic rule for MO is satisfied and the MO root cause is determined to have occurred. The CONTAMINANT data event occurs when a SPC data source 412 asserts that a particular piece of manufacturing equipment is out of control (OOC) and/or out of specifications (OOS). The WRONG MONITORED WAFER data event occurs when the SPC data source 412 asserts that a particular piece of manufacturing equipment is out of control (OOC) and/or out of specifications (OOS) AND a MES data source 416 asserts than a correct recipe has been used. The WRONG RECIPE data event occurs when the SPC data source 412 asserts that a particular piece of manufacturing equipment is out of control (OOC) and/or out of specifications (OOS) AND a MES data source 416 asserts than a correct recipe has been used. Note that the particular combinations of data events for the various diagnostic rules displayed in FIG. 4 are for illustrative purposes only and that different implementations of the diagnostic rules and the data events are possible.

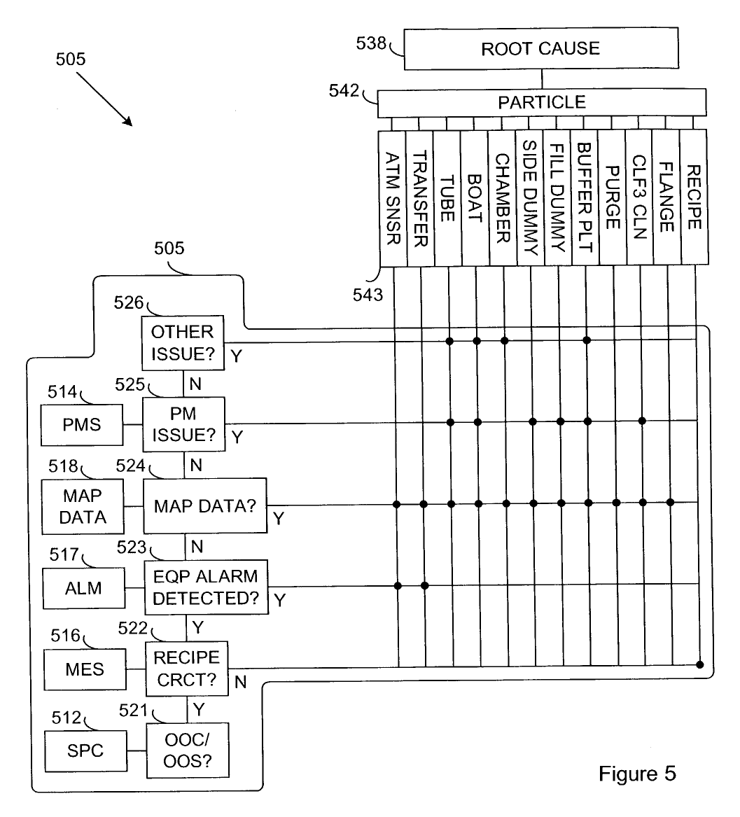

With reference now to FIG. 5, there is shown a diagram illustrating a portion of an abnormal cause diagnostic (such as the abnormal cause diagnostic 305 (FIG. 3)), wherein diagnostic rules for several root causes are displayed, according to a preferred embodiment of the present invention. FIG. 5, as illustrated, displays the remaining portion of an abnormal cause diagnostic that was not shown in FIG. 4. Note that FIG. 4 displayed exemplary diagnostic rules for mis-operation 442, process 444, mechanism 440, vacuum 448, wafer broken 450, and facility 446 related root causes and that FIG. 5 displays an exemplary diagnostic rule for particle related root cause.

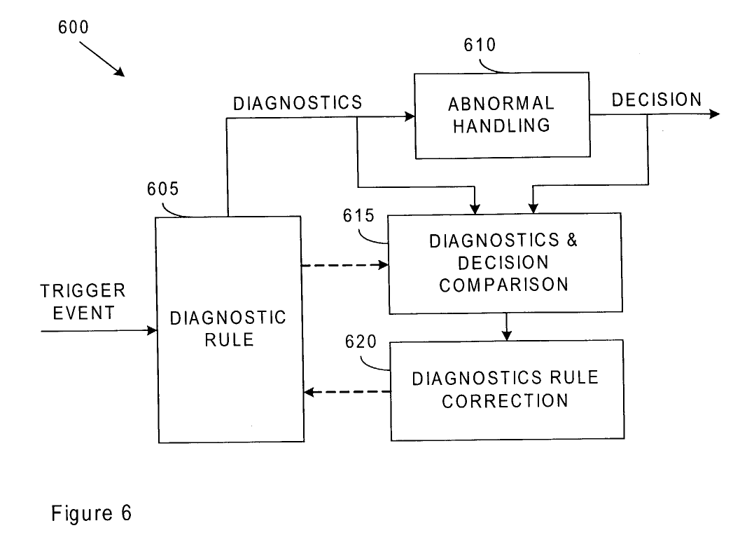

With reference now to FIG. 6, there is shown a diagram illustrating a high-level view of the use of feedback information provided by an engineer to help improve suggested remedies made by an EIEA 600, according to a preferred embodiment of the present invention. The process begins when a trigger event occurs and, based on a unique combination of acquired data from the trigger event, a diagnostic rule for a root cause is satisfied (the acquired data is evaluated in a diagnostic rule unit 605). The root cause, the data associated with the trigger event, and other data is then used to diagnose the trigger event in an abnormal handling unit 610. The abnormal handling unit 610 makes a decision (normally in the form of a remedy) based on the provided data.

Both the diagnostic information that is provided to the abnormal handling unit 610 and the decision made by the abnormal handling unit 610 is provided to a diagnostic and decision comparison unit 615. The diagnostic and decision comparison unit 615 compares the diagnostic information and the decision (and perhaps with any available feedback information that is provided by an engineer) and determines the effectiveness of the decision. Should the decision be rated low on effectiveness, the information is then passed to a diagnostics rule correction unit 620 that is used to make changes to the diagnostic rule for the root cause.

According to a preferred embodiment of the present invention, the process of determining the effectiveness of the decisions made by the abnormal handling unit 610 can occur after each triggering event. Alternatively, the process of determining the effectiveness of the decisions can be made after a certain number of trigger events have occurred or a certain amount of time has elapsed.

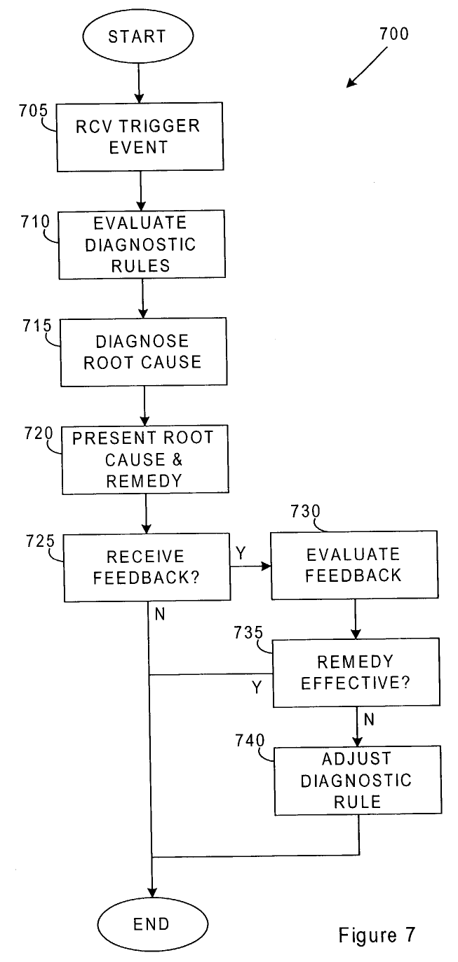

With reference now to FIG. 7, there is shown a flow diagram 700 illustrating an algorithm 700 used in monitoring manufacturing equipment for problems and abnormal events and providing data to assist an engineer in correcting the problems, wherein the algorithm 700 has the ability to self-learn, according to a preferred embodiment of the present invention. According to a preferred embodiment of the present invention, the algorithm 700, as illustrated in FIG. 7, may execute in an EIEA (such as the EIEA 600 (FIG. 6)).

The EIEA 600 may initiate execution of the algorithm 700 when it receives a trigger event (block 705). As discussed previously, a trigger event may come in the form of data from one or more sensors or pieces of measuring equipment (such as the data source 210 (FIG. 2)) that is outside of a specified range. For example, the data may be from a thermostat reporting a temperature that is greater than desired. A relatively simple trigger event may involve a single sensor, while a more complex trigger event may involve more than one sensor. Additionally, more than one trigger event may occur simultaneously (or essentially simultaneously). For example, if an incorrect manufacturing recipe is used, then it is possible to have temperature, pressure, broken wafer, incorrect recipe, and others as trigger events.

After the EIEA 600 receives the data from a data source, the data is used to evaluate the various diagnostic rules (block 710). As discussed in FIG. 4 and FIG. 5, diagnostic rules can be created from combinations of different data from a data source. If the data received matches a combination for a particular diagnostic rule, then that particular diagnostic rule is satisfied. According to a preferred embodiment of the present invention, associated with each diagnostic rule is a root cause (for example, mis-operation (MO), process, and so forth root causes (FIG. 4)). Therefore, when a diagnostic rule is satisfied, it is possible to determine the associated root cause. Note that, like trigger events in which more than one may occur simultaneously, it is possible for more than one diagnostic rule to be satisfied and hence more than one root cause to be determined from the received data.

After the diagnostic rule(s) have been evaluated (block 710) and the root cause(s) determined, the EIEA 600 may attempt to make a diagnosis based on the root cause(s) and the received data (block 715). Based on the root cause(s) and the received data, the EIEA 600 may be able to determine a suitable remedy to correct the problem(s). After diagnosing the root cause (block 715), the EIEA 600 can present root cause, the remedy, and other pertinent information (or some combination thereof) to an engineer (or some other person) who is responsible for correcting the problem (block 720).

After the engineer sees the displayed information and the problem is corrected, the engineer may provide feedback information to the EIEA 600. The feedback information may include a rating on the effectiveness of the remedy presented by the EIEA 600, the completeness of the information displayed, and so forth. The EIEA 600 may wait for the receipt of the feedback information (block 725). If there is no feedback information, the algorithm 700 terminates.

If there is feedback information, the EIEA 600 evaluates the feedback information (block 730). According to a preferred embodiment of the present invention, the feedback information provided by the engineer can be provided in a standardized form that makes it easy to extract data related to the rating of the remedy, the effectiveness of the information displayed, and so forth. Alternatively, the feedback information arrives in free-form and needs to be parsed in order to extract useful information. If there is no form to the feedback information, the feedback information may need to be evaluated and translated by a human operator prior to use by the EIEA 600.

If the remedy provided by the EIEA 600 was rated as being effective (block 735), then the algorithm 700 terminates. If the remedy was rated as not being effective, then the EIEA 600 can make adjustments to its diagnostic rules and diagnosing algorithms to help improve its future performance (block 740). After making the adjustments, the algorithm 700 terminates.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for diagnosing an abnormality comprising:
receiving data from a trigger event;
evaluating satisfaction of diagnostic rules using received data;
determining a root cause if at least one diagnostic rule is satisfied; and
displaying the root cause if at least one diagnostic rule is satisfied, else displaying the received data.

2. The method of claim 1, wherein the trigger event is a result of a monitored value that is outside of a specified range.

3. The method of claim 2, wherein the monitored value is from a piece of manufacturing equipment.

4. The method of claim 3, wherein the piece of manufacturing equipment is used in semiconductor manufacturing.

5. The method of claim 1, wherein a diagnostic rule is a unique combination of the received data.

6. The method of claim 5, wherein a diagnostic rule is satisfied when each piece of received data in its unique combination evaluated true.

7. The method of claim 5, wherein there are a plurality of diagnostic rules and each diagnostic rule is a unique combination of the received data.

8. The method of claim 1, wherein there is a plurality of diagnostic rules, and wherein there is a root cause associated with each diagnostic rule.

9. The method of claim 1, wherein more than one diagnostic rule can be satisfied with the received data.

10. The method of claim 1 further comprising diagnosing the root cause for a remedy if at least one diagnostic rule is satisfied.

11. The method of claim 10, wherein the displaying includes displaying the remedy.

12. A method for self-learning diagnostics comprising:
receiving data from a trigger event;
evaluating satisfaction of diagnostic rules using received data;
if at least one diagnostic rule is satisfied, then determining a root cause;
diagnosing a remedy for the root cause;
displaying the remedy;
receiving feedback information about the remedy; and
modifying the satisfied diagnostic rule with the feedback information.

13. The method of claim 12, wherein the feedback information provides a rating on the effectiveness of the remedy.

14. The method of claim 12, wherein the feedback information is also used to modify the diagnosing.

15. The method of claim 12, wherein the feedback information is provided by a user.

16. An equipment diagnosis system comprising:
a data source to provide information from sensors and measuring equipment;
an inference engine coupled to the data source, the inference engine containing circuitry to evaluate the information provided by the data source and to diagnose a root cause from the information;
a display coupled to the inference engine, the display to interface the inference engine with a user; and
a database coupled to the inference engine, the database to store information provided by the data source and the diagnosis generated by the inference engine.

17. The equipment diagnostic system of claim 16, wherein the data source provides information only when a trigger event occurs.

18. The equipment diagnostic system of claim 17, wherein a trigger event is when a sensor detects a value outside of a specified range.

19. The equipment diagnostic system of claim 16 further comprising a user interface coupled to the inference engine, the user interface to permit a user to input information.

20. The equipment diagnostic system of claim 19, wherein the input information includes feedback information regard the effectiveness of a diagnosis provided by the inference engine.

21. The equipment diagnosis system of claim 19, wherein the input information is used to make adjustments to the inference engine.
